(19) United States
(12) Patent Application Publication
(10) Pub. No.: US 2014/0286520 A1
(43) Pub. Date: Sep. 25, 2014

(54) CLOSED-BACK HEADPHONE

(71) Applicant: PANASONIC CORPORATION, Osaka (JP)

(72) Inventor: Yushi OGINO, Hyogo (JP)

(21) Appl. No.: 14/300,737

(22) Filed: Jun. 10, 2014

Related U.S. Application Data
(63) Continuation of application No. PCT/JP2012/007862, filed on Dec. 7, 2012.

(30) Foreign Application Priority Data
Dec. 16, 2011 (JP) 2011-275414

(51) Int. Cl. H04R 1/10

(52) U.S. Cl. CPC H04R 1/1091
USPC 381/371

(57) ABSTRACT

A closed-back headphone includes a housing (111b) and an ear pad (111a). The housing (111b) includes a speaker unit. The ear pad (111a) is mounted on the housing (111b) and is a ring-shaped cushion surrounding an ear of a user (401). The ear pad (111a) includes an upper part (P1) for covering an upper portion of the ear, and a lower part (P2). The upper part (P1) is softer than the lower part (P2).

### CROSS-REFERENCE TO RELATED APPLICATIONS

This is a continuation of International Application No. PCT/JP2012/007862 filed on Dec. 7, 2012, which claims priority to Japanese Patent Application No. 2011-275414 filed on Dec. 16, 2011. The entire disclosures of these applications are incorporated by reference herein.

### BACKGROUND

The present disclosure relates to headphones for reproducing audio signals.

Japanese Unexamined Patent Publication No. 2002-101483 discloses a headphone for a user who wears glasses or earrings. This headphone includes right and left housings, each including a speaker unit. These housings are attached on pads, each including a notch for accommodating a temple of the glasses worn by the user.

### SUMMARY

The present disclosure provides a headphone that is comfortably wearable for the user with glasses, and capable of keeping the portions around the ears sealed.

The closed-back headphone of the present disclosure includes left and right ear housings, each including a speaker unit. The closed-back headphone also includes an ear pad mounted on each of the left and right ear housings, and being a ring-shaped cushion surrounding an ear of the user. The ear pad includes an upper part for covering an upper portion of the ear, and a lower part positioned below the upper part. The upper part differs in hardness from the lower part. The upper part is softer than the lower part.

The present disclosure provides a headphone that is comfortably wearable for the user with glasses, and capable of keeping the portions around the ears sealed.

### BRIEF DESCRIPTION OF THE DRAWINGS

FIG. 1 is a front view of a closed-back headphone of an embodiment.

FIG. 2 is a plan view of the closed-back headphone of the embodiment.

FIG. 3 is a right side view of the closed-back headphone of the embodiment.

FIG. 4 is a sectional view of an ear pad of the closed-back headphone of the embodiment.

FIG. 5 illustrates a user who wears the closed-back headphone of the embodiment.

### DETAILED DESCRIPTION

Embodiments are described in detail below with reference to the attached drawings. However, unnecessarily detailed description may be omitted. For example, detailed description of well known techniques or description of the substantially same elements may be omitted. Such omission is intended to prevent the following description from being unnecessarily redundant and to help those skilled in the art easily understand it.

The inventor provides the following description and the attached drawings to enable those skilled in the art to fully understand the present disclosure. Thus, the description and the drawings are not intended to limit the scope of the subject matter defined in the claims.

### First Embodiment

### 1-1. Configuration

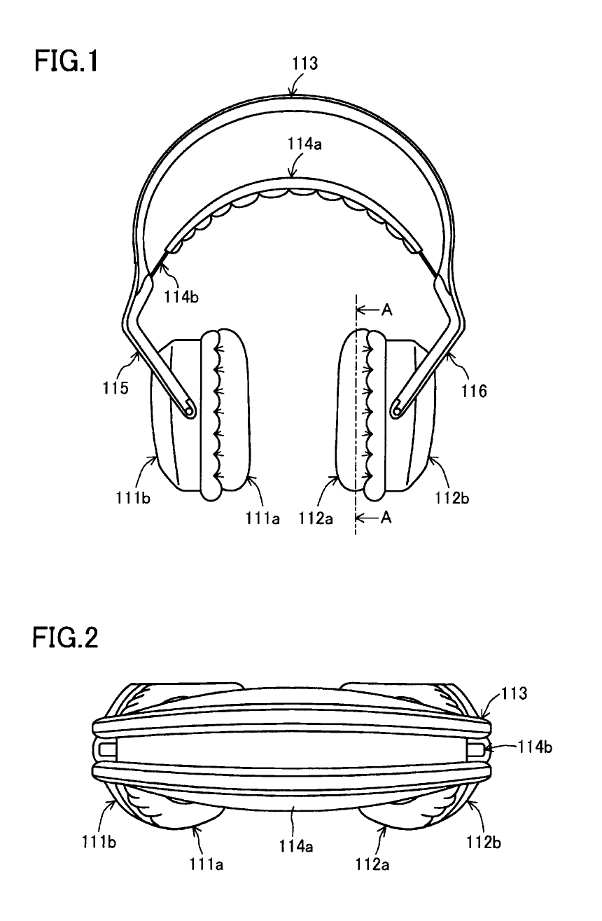

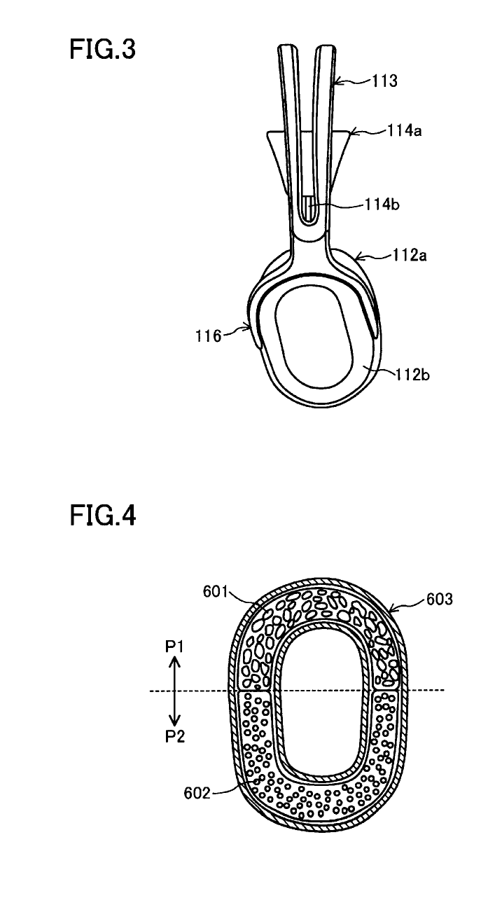

FIGS. 1-3 illustrate a configuration of a closed-back headphone of this embodiment. FIG. 1 is a front view. FIG. 2 is a plan view. FIG. 3 is a right side view.

FIGS. 1-3 illustrate a left ear pad 111a, a left ear housing 111b, a right ear pad 112a, and a right ear housing 112b. The left ear housing 111b and the right ear housing 112b each includes a speaker unit with a hole (not shown) for radiating sound energy. The hole is disposed on a front surface of the speaker unit, i.e., a surface that faces an ear of a user. The left ear pad 111a surrounding the hole is attached on the left ear housing 111b. The right ear pad 112a surrounding the hole is attached on the right ear housing 112b. The left ear pad 111a and the right ear pad 112a are ring-shaped cushions for covering the ears of the user entirely.

The figures also illustrate a headband 113, a head pad 114a, a head pad rubber 114b, a left arm 115, and a right arm 116. The left arm 115 and the right arm 116 support the left ear housing 111b and the right ear housing 112b, respectively. The headband 113 couples the left arm 115 with the right arm 116. The headband 113, the left arm 115, and the right arm 116 support the left ear housing 111b and the right ear housing 112b so that the holes of the speaker units face each other. The left arm 115 and the right arm 116 also support the left ear housing 111b and the right ear housing 112b, respectively, so that the left ear housing 111b and the right ear housing 112b each rotates on an axis along the front-back direction around the ear of the user. This configuration allows the left ear pad 111a of the headphone worn by the user to be in intimate contact with the left ear of the user, and the right ear pad 112a to be in intimate contact with the right ear of the user.

On an inner side of the headband 113, i.e., a user's head side, provided are the head pad 114a to be mounted on the head of the user and the extendable head pad rubber 114b disposed inside a hollow of the head pad 114a. The head pad rubber 114b is connected with the left arm 115 for supporting the left ear housing 111b and the right arm 116 for supporting the right ear housing 112b. This configuration enables the length of the head pad rubber 114a of the headphone worn by the user to vary depending on the size of the head of the user, and allows the left housing 111b and the right housing 112b to be appropriately positioned over the ears of user.

This headphone includes an electric circuit (not shown) that receives and amplifies audio signals transmitted by, e.g., radio. The audio signals are reproduced by the speaker units in the left ear housing 111b and the right ear housing 112b. Alternatively, the audio signals are input to the headphone through a cord, and reproduced by the speaker units in the left ear housing 111b and the right ear housing 112b.

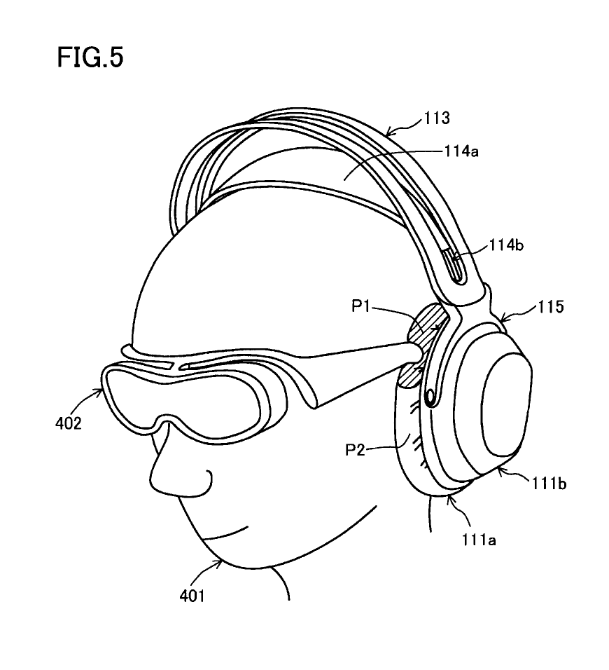

FIG. 4 illustrates a structure of the ear pad, or specifically, a sectional view taken along line A-A of the right ear pad 112a in FIG. 1. The same configuration applies to the left ear pad 111a. FIG. 4 illustrates the ear pad that includes cushion materials 601 and 602 packed with a sheet 603. The ear pad is ring shaped and has an enough inner diameter to surround the ear of the user with a free space. The cushion materials 601 and 602 are soft materials produced by foaming, e.g., polyurethane resin or synthetic rubber. The sheet 603 is, e.g., a synthetic leather, polyvinyl chloride, or a cloth that is soft, noise-canceling materials.

The ear pad includes an upper part P1 for covering an upper portion of the ear and a lower part P2 positioned below the upper part P1. The upper part P1 includes the soft sponge 601 having a high foaming rate. The lower part P2 includes the hard sponge 602 having a low foaming rate. That is, when the user with glasses wears the headphone of this embodiment, the upper part P1 including the soft sponge 601 is in contact with the temple of the glasses. The soft sponge 601 is neither bonded to nor fixed to the sheet 603. The soft sponge 601 is bonded to and fixed to, or integrated with the hard sponge 602 at the boundary between the upper part P1 and the lower part P2.

### 1-2. Operation

Operation of the above headphone will be described.

FIG. 5 illustrates the user with glasses who wears the headphone of this embodiment. To wear the headphone, the user 401 with the glasses 402 holds the left ear housing 111b and the right ear housing 112b in both hands. Then, the user 401 expands the headband 113 and attaches the head pad 114a on the head of the user. Then, the user 401 has the left ear pad 111a surround the left earlobe of the user, and the right ear pad 112a surround the right earlobe of the user. The extendable head pad rubber 114b varies in length with a positional relation between the head and ears of the user 401. This prevents the left ear pad 111a and the right ear pad 112a from slipping out of the positions where they surround the earlobes.

The temples of the glasses 402 of the user 401 are in contact with the upper parts P1 (hatched in FIG. 5) of the left ear pad 111a and the right ear pad 112a, i.e., in contact with a portion including the soft sponge 601 serving as a cushion material. The soft sponge 601 is deformable with gentle pressure. That is, the upper part P1 includes a portion that is in contact with the temple of the glasses 402 and is pushed and deformed with the temple. In contrast, the lower part P2 including the hard sponge 602 serving as a cushion material is fully hard and hardly deformed. This enables the ears of the user 401 to keep a fixed distance from the left ear housing 111b and the right ear housing 112b. Thus, the upper part P1 including the soft sponge 601 is not deformed by more than the fixed distance as a whole. In other words, only the portion that is in contact with the temple of the glasses 402 is deformed to surround the temple.

This configuration does not allow the left ear pad 111a and the right ear pad 112a to press the temples of the glasses 402 hard, thereby enabling the user 401 with the glasses 402 to wear the headphone comfortably. There are also no spaces between the left ear pad 111a and the temple of the glasses 402 and between the right ear pad 112a and the temple of the glasses 402. This configuration keeps the headphone sealed, thereby avoiding impairment of the noise-canceling performance and the bass reproduction performance due to sound leakage.

If the user 401 does not wear the glasses, the upper part P1 is not deformed and the headphone is kept sealed. That is, the headphone of this embodiment is wearable independently of the existence of the glasses, and keeps the portions around the ears sealed.

### 1-3. Advantages etc.

A conventional headphone includes an ear pad with a notch that is not in contact with a temple of glasses, and the sound is leaked from this notch. Alternatively, the conventional headphone includes a fixed notch that does not allow a pad of the headphone to be well positioned on the user depending on a width of the temple of the glasses, thereby making the user feel uncomfortable.

In contrast, the closed-back headphone of this embodiment includes the ring shaped ear pads, each including the upper part P1 including the soft sponge 601, and the lower part P2 including the hard sponge 602. This configuration makes the user with glasses feel comfortable, and avoids impairment of the noise-canceling performance and the bass reproduction performance due to sound leakage.

In recent years, audio-visual systems for 3D image entertainment have become popular. The user often wears a headphone with a pair of 3D image glasses. A temple of the 3D image glasses is larger than that of normal glasses. The temple of the 3D image glasses is, e.g., about 15 mm in width and about 8 mm in thickness. The closed-back headphone of this embodiment does not allow the temple of the 3D image glasses to push the ear of the user, and thus prevents the user from feeling uncomfortable and tired. The closed-back headphone of this embodiment is also very useful because it does not cause the sound leakage. The closed-back headphone of this embodiment provides the above advantages independently of the width and thickness of the temple of the glasses.

The materials etc. of the members are not limited to the above examples.

The upper part P1 includes the soft sponge 601 and the sheet 603 packing the soft sponge 601. The soft sponge 601 is neither bonded to nor fixed to the sheet 603. Thus, the soft sponge 601 slides on the sheet 603, and is more likely to be deformed. Thus, the portion that is in contact with the temple of the glasses 402 is deformed with less pressure. This makes the user feel more comfortable.

The boundary between the upper part P1 and the lower part P2 is preferably positioned above the axis on which the left ear housing 111b and the right ear housing 112b rotate. That is, the rotation axis is positioned in the lower part P2 that is relatively hard. Thus, the positions of the left ear housing 111b and the right ear housing 112b are stable when the user wears the headphone.

### Another Embodiment

As described above, the first embodiment has been described as example techniques disclosed in the present application. However, the techniques according to the present disclosure are not limited to these embodiments, but are also applicable to those where modifications, substitutions, additions, and omissions are made.

Another embodiment will be described below.

The ear pad of the above embodiment has the two part structure: the upper part and the lower part. Alternatively, the ear pad may have, e.g., a three part structure: a contact part, an upper part, and a lower part. The contact part is in contact with the temple, and includes a soft sponge. The upper part is positioned above the contact part, and includes a hard sponge. The lower part is positioned below the contact part, and includes a hard sponge. However, this complex structure increases the production cost.

The cushion material for the ear pad of the above embodiment is a foamed sponge. Alternatively, the ear pad may include, for example, a U-shaped rubber that is ring-shaped. Thickness variation in the rubber provides the hardness difference.

Various embodiments have been described above as example techniques of the present disclosure, in which the attached drawings and the detailed description are provided.

As such, elements illustrated in the attached drawings or the detailed description may include not only essential elements for solving the problem, but also non-essential elements for solving the problem in order to illustrate such techniques. Thus, the mere fact that those non-essential elements are shown in the attached drawings or the detailed description should not be interpreted as requiring that such elements be essential.

Since the embodiments described above are intended to illustrate the techniques in the present disclosure, it is intended by the following claims to claim any and all modifications, substitutions, additions, and omissions that fall within the proper scope of the claims appropriately interpreted in accordance with the doctrine of equivalents and other applicable judicial doctrines.

The present disclosure provides a headphone that is comfortably wearable for the user with glasses, and capable of keeping the portions around the ears sealed. Specifically, the present disclosure is useful for, e.g., a 3D image system etc.

What is claimed is:

1. A closed-back headphone, comprising:
left and right ear housings, each including a speaker unit; and
an ear pad mounted on each of the left and right ear housings, and being a ring-shaped cushion surrounding an ear of a user, wherein
the ear pad includes an upper part for covering an upper portion of the ear and a lower part positioned below the upper part,
the upper part differs in hardness from the lower part, and
the upper part is softer than the lower part.

2. The closed-back headphone of claim 1, wherein
the upper part of the ear pad is in contact with a temple of glasses worn by the user.

3. The closed-back headphone of claim 1, wherein
the ear pad includes cushion materials packed with a sheet,
one of the cushion materials for the upper part is a first material that is relatively soft,
the other cushion material for the lower part is a second material that is relatively hard, and
the first material for the upper part is neither bonded to nor fixed to the sheet.

4. The closed-back headphone of claim 3, wherein
the first material is bonded to or integrated with the second material at a boundary between the upper part and the lower part.

5. The closed-back headphone of claim 1, comprising:
left and right arms supporting the left and right ear housings, respectively; and
a headband coupling the left arm with the right arm, wherein
the left and right arms support the left and right ear housings, respectively, so that the left and right ear housings each rotates on an axis along a front-back direction around the ear of the user, and
the boundary between the upper part and the lower part of the ear pad is positioned above the axis.

6. The closed-back headphone of claim 5, comprising:
an extendable head pad rubber disposed on a user's head side of the headband, and connected with the left arm and the right arm.
